(19) United States
(12) Patent Application Publication
(10) Pub. No.: US 2010/0272554 A1
(43) Pub. Date: Oct. 28, 2010

(54) TANK TRUCK WITH SIDE-SHOOTING DISCHARGE

(76) Inventor: Donald L. Mensch, Byron Center, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/429,302

(22) Filed: Apr. 24, 2009

(51) Int. Cl. B65G 67/02; B60P 1/00

(52) U.S. Cl. 414/813; 414/523; 414/518

(57) ABSTRACT

A truck includes a steerable frame having a tank with structure defining a forwardly-facing front discharge opening and an auger for moving material in the tank to the discharge opening. A subassembly is attached to the structure for receiving a stream of the material from the front discharge opening. The subassembly includes a laterally-facing tube with an outlet opening oriented to dump material from the tank in a sideways direction near a front of the steerable frame. In one form, the subassembly is configured to replace a guillotine plate gate covering the discharge opening for normal front dumping of material, the subassembly allowing material to be dumped to a side instead of toward the front.

### BACKGROUND

The present invention relates to tank trucks having a discharge system for discharging flowable material in a sideways direction.

Vacuum trucks are known for scrapingly collecting and then vacuuming up manure, bedding, and debris into a tank on the trucks. For example, one such vacuum truck is shown in U.S. application Ser. No. 12/127,292, filed on May 27, 2008, entitled VACUUM TRUCK WITH COLLAPSIBLE SCRAPER AND PIVOT RELIEF. This truck is particularly adapted to dump collected material from its tank forwardly at a location where dumping is easily seen and supervised by an operator in a front cabin of the truck. However, in some situations, vehicle operators want to drive up adjacent a dump site/dump facility and unload . . . rather than drive up directly to the dump site with the front of the vehicle facing the dump site.

### SUMMARY OF THE PRESENT INVENTION

In one aspect of the present invention, a truck includes a steerable frame having a tank thereon with structure defining a forwardly-facing front discharge opening and an auger for moving material in the tank to the discharge opening. A subassembly is attached to the structure for receiving a stream of the material from the front discharge opening. The subassembly includes a laterally-facing tube with an outlet opening oriented to dump material from the tank in a sideways direction near a front of the steerable frame.

In another aspect of the present invention, a side shooter apparatus is adapted for attachment to a front of a steerable vehicle, where the vehicle has a tank with front discharge opening for dumping flowable material in the tank. The apparatus includes a subassembly with a subframe adapted for attachment to the front of the vehicle, and further includes a housing with an inlet opening adapted for positioning in alignment with the front discharge opening. A laterally-facing tube with an outlet opening is attached to the housing and oriented to dump material from the housing in a sideways direction near the front of the vehicle. A motivator is included in the housing for motivating the flowable material from the inlet opening to and out of the outlet opening.

In another aspect of the present invention, a method includes steps of providing a steerable frame having a tank thereon with structure defining a forwardly-facing front discharge opening and an auger for moving material in the tank to the discharge opening. A subassembly is attached to the structure for receiving a stream of the material from the front discharge opening, the subassembly having a laterally-facing tube with an outlet opening. The method further includes dumping material from the tank through the subassembly out the outlet opening in a sideways direction near a front of the steerable frame.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a vacuum truck embodying the present invention.

FIGS. 2-4 are front, side and exploded perspective views of FIG. 1.

FIGS. 5-10 are left perspective, top, right perspective, left side, front and right side views of the subassembly shown in FIG. 1.

### DETAILED DESCRIPTION OF PREFERRED EMBODIMENTS

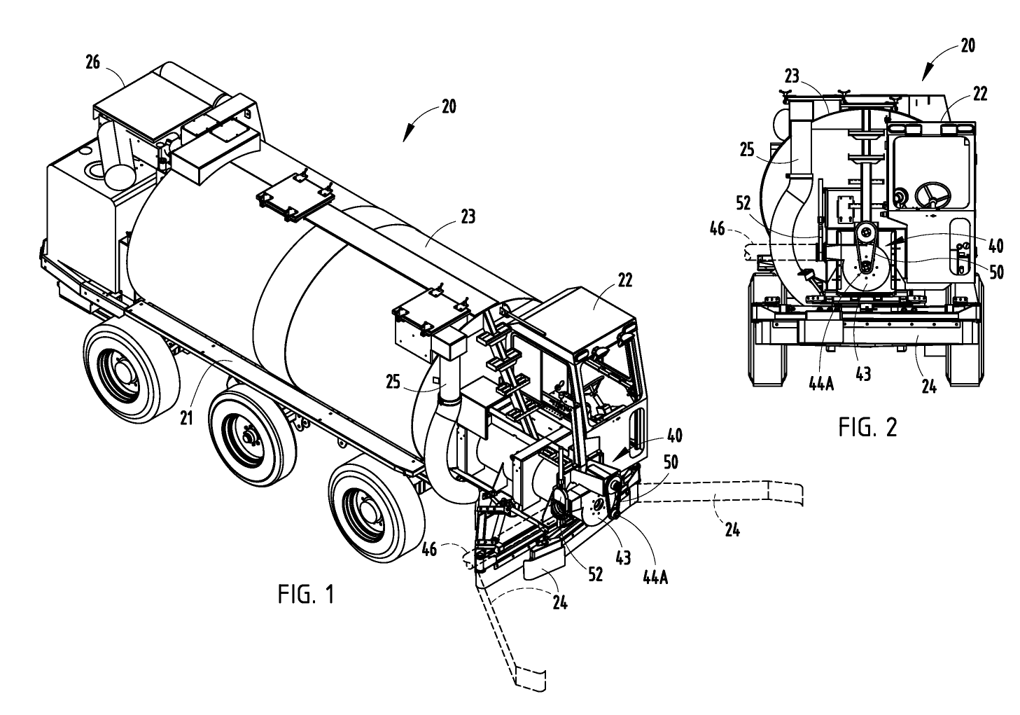

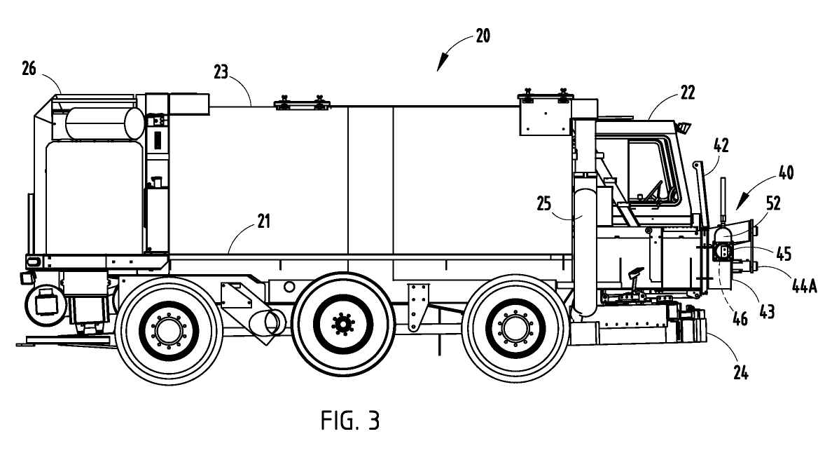

A truck vehicle 20 (FIG. 1) includes a self-motivated steerable wheeled frame 21 with a forward cabin 22 for operating the vehicle 20. A tank 23 on the frame 21 is arranged to hold manure and debris that is collected by a scraper 24 and moved to the tank 23 through a large hose vacuum line 25 of a vacuum system 26. Additional information about the truck and vacuum system can be obtained from U.S. application Ser. No. 12/127,292, filed on May 27, 2008, entitled VACUUM TRUCK WITH COLLAPSIBLE SCRAPER AND PIVOT RELIEF, the entire contents of which are incorporated herein in their entirety.

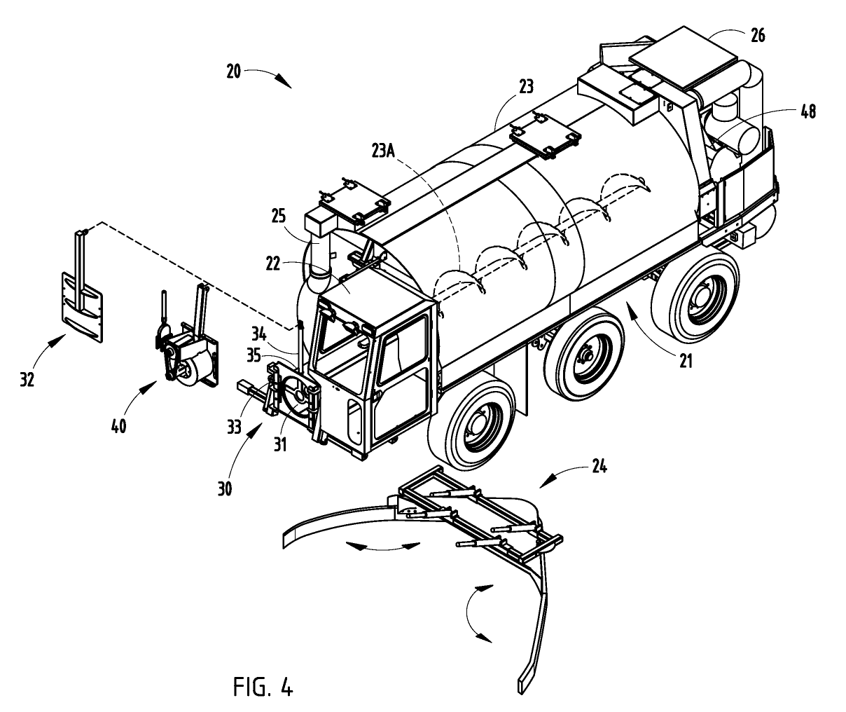

A front structure 30 (FIG. 4) on the steerable frame 21 forms a forwardly-facing front discharge opening 31 under the cabin 22 for dumping material from the tank 23 in front of the vehicle 20. A guillotine gate 32 is mounted on a vertical track 33 formed by the structure 30 for vertical movement to open (and close) the discharge opening 31, and an actuator 34 on the front structure 30 is positioned to selectively vertically move the gate 32 as desired. An internal auger 23A is positioned longitudinally in the tank 23 for moving material in the tank 23 forward from the tank 23 through a tube section 35 to the discharge opening 31.

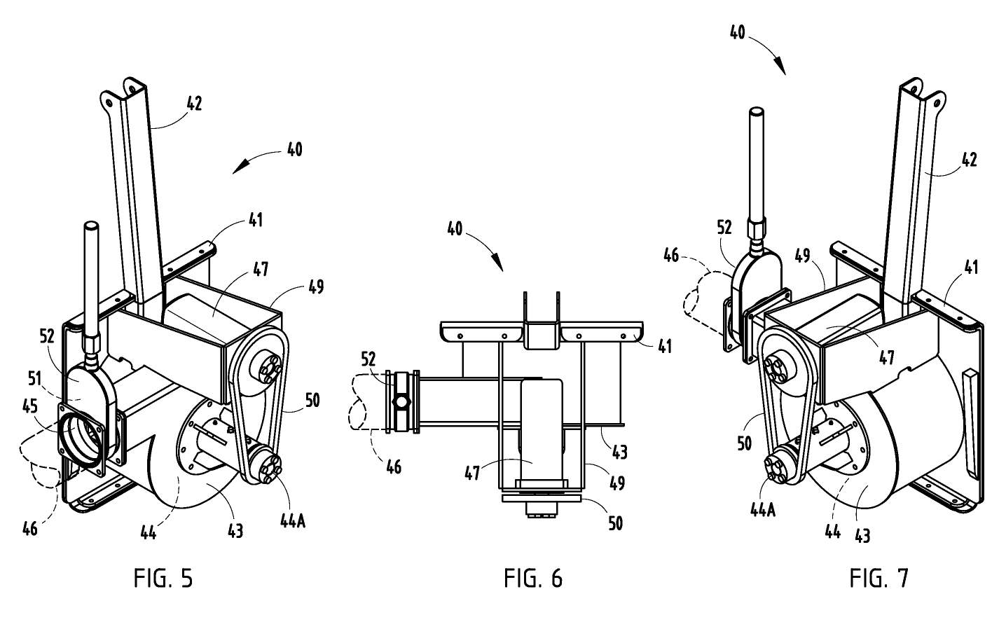

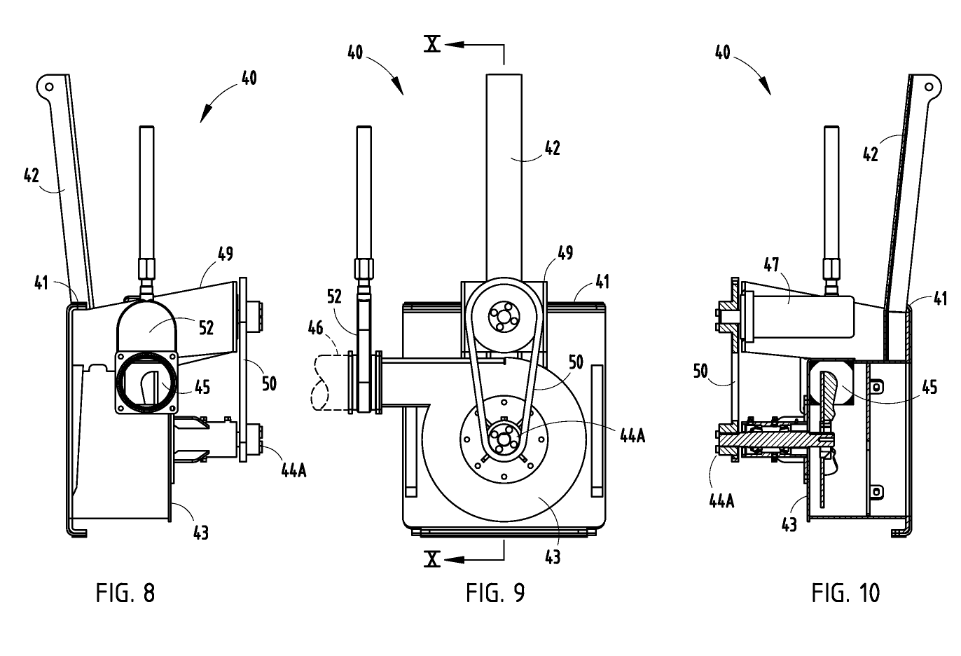

The guillotine gate 32 can be replaced by a subassembly 40 configured for attachment to the front structure 30 for receiving a stream of the material from the front discharge opening 31. The subassembly 40 (FIG. 5) includes plate 41 similar to gate 32 and that mates with the track 33. A mounting arm 42 extends from the gate 32 for connection to the actuator 34, thus anchoring the subassembly 40 in front of the vehicle 20, with an inlet opening in the plate 41 being aligned with the discharge opening 31. A housing 43 attached to the plate 41 defines a chamber for an impeller motivator 44 and drive 44A, and includes a side-facing exit opening 45. A discharge extender tube 46 extends from the exit opening 45 laterally toward a side of the vehicle frame 21. A hydraulic motor 47 connected to the power plant (engine) 48 of the vehicle 20 is mounted on a U-shaped subframe 49 above the motivator 44 and connected to the motivator drive 44A by a chain drive 50 (or belt drive). The housing 43 and motivator 44 form a pump for motivating material such as collected manure, bedding, and debris from the tank 23 (via the auger and tube section 35) through discharge opening 31, and motivating it laterally out the extender tube 46. A guillotine shut-off blade 51 is mounted in a housing 52 at the lateral outlet opening 45.

In operation, auxiliary shut-off blade 51 is opened and auger 23A and motivator 44 activated to move the contents of tank 23 to subassembly 40, and laterally out of discharge extender tube 46 toward a side of the truck 20. The truck 20 can be stationary or moving during the unload operation.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is: claimed are defined as follows:

1. A vehicle comprising:
a steerable frame having a tank thereon with structure defining a forwardly-facing front discharge opening and an auger for moving material in the tank to the discharge opening; and
a subassembly attached to the structure for receiving a stream of the material from the front discharge opening and having a laterally-facing tube with an outlet opening oriented to dump material from the tank in a sideways direction near a front of the steerable frame.

2. The vehicle defined in claim 1, wherein the subassembly includes a plate attached to the structure.

3. The vehicle defined in claim 1, wherein the plate closes the front discharge opening except for an inlet opening defined in the plate.

4. The vehicle defined in claim 1, wherein the subassembly includes a motivator for motivating flowable material from the inlet opening to and out of the outlet opening.

5. The vehicle defined in claim 1, wherein the subassembly includes a housing that houses the motivator.

6. The vehicle defined in claim 5, wherein the housing and motivator form a pump adapted to move viscous fluid from the tank.

7. The vehicle defined in claim 1, including a vacuum loader mounted on the truck.

8. The vehicle defined in claim 1, including a scraper on the truck.

9. A side shooter apparatus adapted for attachment to a front of a steerable vehicle having a tank with front discharge opening for dumping flowable material in the tank, comprising:
a subassembly including a subframe adapted for attachment to the front of the vehicle, the subassembly including a housing with an inlet opening adapted for positioning in alignment with the front discharge opening, a laterally-facing tube with an outlet opening oriented to dump material from the housing in a sideways direction near the front of the vehicle, and a motivator in the housing for motivating the flowable material from the inlet opening to and out of the outlet opening.

10. The vehicle defined in claim 9, wherein the subassembly includes a plate attached to the structure.

11. The vehicle defined in claim 10, including a plate closing the front discharge opening except for the inlet opening defined in the plate.

12. The vehicle defined in claim 10, wherein the housing and motivator form a pump adapted to move viscous fluid from the tank.

13. A method comprising steps of:
providing a steerable frame having a tank thereon with structure defining a forwardly-facing front discharge opening and an auger for moving material in the tank to the discharge opening; and
attaching a subassembly to the structure for receiving a stream of the material from the front discharge opening, the subassembly having a laterally-facing tube with an outlet opening; and
dumping material from the tank through the subassembly out of the outlet opening in a sideways direction near a front of the steerable frame.

14. The vehicle defined in claim 13, wherein the structure includes a vertical track, and wherein the subassembly includes a plate attached to the vertical track on the truck.
